(19) United States
(12) Patent Application Publication
(10) Pub. No.: US 2013/0076538 A1
(43) Pub. Date: Mar. 28, 2013

(54) DRIVING ASSIST APPARATUS AND PROGRAM FOR THE SAME

(71) Applicants: Masahiro Uno, Okazaki-city (JP); Michinaga Nagura, Toyohashi-city (JP)

(72) Inventors: Masahiro Uno, Okazaki-city (JP); Michinaga Nagura, Toyohashi-city (JP)

(73) Assignee: DENSO CORPORATION, Kariya-city (JP)

(21) Appl. No.: 13/614,343

(22) Filed: Sep. 13, 2012

(30) Foreign Application Priority Data
Sep. 28, 2011 (JP) 2011-213001

(51) Int. Cl. G08G 1/0967

(52) U.S. Cl. 340/905

(57) ABSTRACT

A driving assist apparatus for an own vehicle is disclosed. The driving assist apparatus acquires light color change information and traffic light location information from at least one of the own vehicle and a different vehicle. The light color change information is information indicative of a change in light color of a traffic light. The traffic light location information is information indicative of location of the traffic light. The driving assist apparatus prediction device predicts a traffic light color change time, based on the light color change information and the traffic light location information. The driving assist apparatus assists a driver in driving the own vehicle in accordance with the light color change time.

### CROSS REFERENCE TO RELATED APPLICATION

The present application is based on and claims priority to Japanese Patent Application No. 2011-213001 filed on Sep. 28, 2011, disclosure of which is incorporated herein by reference.

### TECHNICAL FIELD

The present disclosure relates to a driving assist apparatus for assisting a driver in driving the vehicle. The present disclosure further relates to a non-transitory computer readable storage medium storing a processor-executable program for assisting a driver in driving the vehicle.

### BACKGROUND

A known driving assist apparatus receives traffic light information, which indicates traffic light cycle (e.g., a time of changing light color or the like), from a transmitter on a road. Based on this traffic light information, the driving assist apparatus notifies a light color change of traffic light in advance. For such a driving assist apparatus, see JP 2009-015510A.

According to such driving assist apparatuses, however, many transmitters transmitting the traffic signal information are required for effective driving assistance. For example, when the transmitter associated with a certain traffic light is absent, the driving assist apparatus cannot recognize the traffic color change of the certain traffic light.

### SUMMARY

In view of the foregoing, it is an object of the present disclosure to provide a driving assist apparatus that can recognize a change in light color of a traffic, light even when a transmitter for transmitting'a traffic light information is absent. It is also an object of the present disclosure to provide a non-transitory computer readable storage medium storing a program for such a driving assist apparatus.

According to an example of the present disclosure, a driving assist apparatus for being mounted to an own vehicle to assist a driving operation of a driver of the own vehicle includes a traffic light information acquisition device, a light color change prediction device, an own vehicle position acquisition device, and an assist device. The traffic light information acquisition device acquires light color change information and traffic light location information from at least one of the own vehicle and a different vehicle different than the own vehicle. The light color change information is information indicating that light color of a traffic light has been changed. The traffic light location information is information indicative of location of the traffic light. The light color change prediction device predicts, based on the light color change information and the traffic light location information, a light color change time, which is a time of changing the light color of the traffic light. The own vehicle position acquisition device acquires information indicative of position of the own vehicle. The assist device assists the driving of the own vehicle in accordance with the position of the own vehicle and the light color change time.

According to the above configuration, even when a transmitter for transmitting traffic light information is absent, the driving assist apparatus can recognize a change in light color of a traffic light and can provide assistance in accordance with the time of changing the light color of the traffic light.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a driver assist system;

FIG. 2 is a diagram illustrating a display device;

FIG. 3A is a diagram illustrating an own vehicle and different vehicles around an intersection;

FIG. 3B is a diagram illustrating a relation between traffic light color and time;

FIG. 4 is a flowchart illustrating a target speed setting process;

FIG. 5 is a diagram for explanation on definitions of notations Vmax etc.;

FIGS. 6A and 6B are diagrams illustrating a time for an own vehicle to stop by decelerating;

FIG. 7 is a flowchart illustrating a signal cycle estimation process;

FIG. 8A is a graph illustrating a relation between time and position of each vehicle;

FIG. 8B is a graph illustrating a relation between different value (time) and frequency (vote count);

FIG. 9 is a flowchart illustrating an intersection green time estimation process;

FIG. 10 is a flowchart illustrating a notification process;

FIG. 11 is a graph illustrating a relation between notification start speed and notification end speed;

FIG. 12 is a flowchart illustrating a road information adding process; and

FIGS. 13A, 13B and 13C are diagrams illustrating vehicle swept paths.

### DETAILED DESCRIPTION

Embodiments will be described with reference to the drawings.

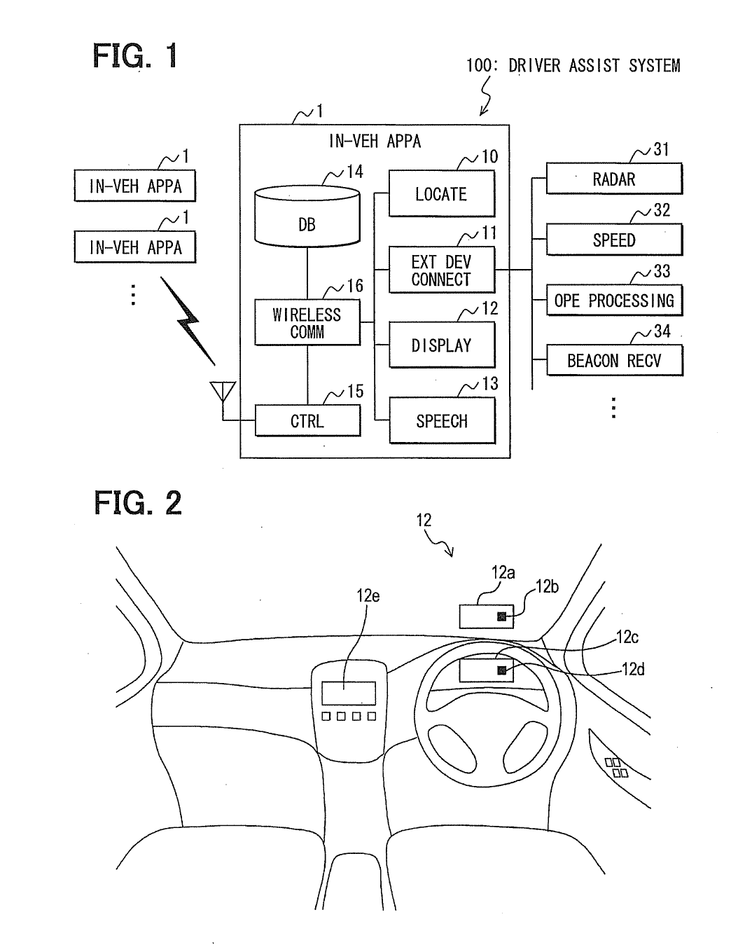

A configuration of a driver assist system 100 of one embodiment will be described with reference to FIG. 1. The driver assist system 100 includes in-vehicle apparatuses 1 (also called a driver assist apparatus or a driving assist apparatus) mounted to respective multiple vehicles. The in-vehicle apparatus 1, which is mounted on an own vehicle, can assist driver's driving operation of the own vehicle. In the present embodiment in particular, the in-vehicle apparatus 1 predicts traffic light cycle (e.g., traffic light change schedule) and provides assistance to enable the own vehicle not to stop at the traffic light.

The in-vehicle apparatus 1 of each vehicle can perform inter-vehicle communication with the in-vehicle apparatus 1 of another vehicle. The in-vehicle apparatuses 1 of respective vehicles may have substantially the same configuration. For simplification, only a certain one of the in-vehicle apparatuses 1 is depicted in FIG. 1.

As shown in FIG. 1, the in-vehicle apparatus 1 includes a locating device 10, an external-device connection device 11, a display device 12, a speech output device 13, a database 14 (stored in a storage), a wireless communication device 15, a controller 16 etc.

The locating device 10 detects a present position and a heading direction of the vehicle based on a vehicle speed sensor 32, a light beacon receiver 34, a GPS receiver (not shown), a gyroscope (not shown) or the like. The locating device 10 outputs a data indicative of the present position and the heading direction of the vehicle to the controller 16. From a light beacon transmitter located before an intersection, the light beacon receiver 34 receives information indicative of a distance to the intersection, information indicative of, for example, location of the beacon transmitter, traffic information, or the like.

The external-device connection device 11 can serve as an interface for communicating with a variety of devices such as a radar 31, a vehicle speed sensor 32, a light beacon receiver 34, an operation processor 33, or the like. The operation processor 33 may be included in another electronic control unit (ECU). The external-device connection device 11 inputs the vehicle information, which is sent from the devices, to the controller 16.

The display device 12 is provided with a display screen for displaying an image. The display screen may be a liquid crystal panel or the like. The display device 12 displays a variety of driving assist images under control of the controller 16. The display screen for image display may be placed where the display screen is viewable from a driver seat of the vehicle.

More specifically, as shown in FIG. 2, the display device 12 may be provided with a head-up display 12a, a meter display 12c (e.g., a display in an instrumental panel), a liquid crystal display 12e of a navigation apparatus, or the like. In particular, the head-up display 12a may display an acceleration/deceleration indicator image 12b with a predetermined shape. The meter display 12c may light on/off and blink, a light emitter 12d having a predetermined shape. The liquid crystal display 12e may display a predetermined-shaped image, like the head-up display 12a does.

These lighting portions, such as the acceleration/deceleration indicator image 12b, the light emitter 12d or the like, may light up with one color selected from two or more colors, which may include for example green and red. For simplification, it is assumed that the in-vehicle apparatus 1 includes only the head-up display 12a, which can display the acceleration/deceleration indicator image 12b.

The speech output device 13 may include a speaker or the like for outputting speech. The speech output device 13 can output a variety of guidance speech for driving assistance based on control by the controller 16. The database 14 stores traffic light information generated in the own vehicle. The database 14 may be stored in a storage, which may include a non-volatile memory such as flush memory, hard disk drive or the like.

The traffic light information includes information indicative of the present and future light color of each traffic light (also called a traffic signal). In other words, the traffic light information includes information about schedule of color of a traffic light. The traffic light information further includes information indicating where the traffic light is located. The traffic light information stored in the database 14 is used for driving assist control, which is performed when the vehicle travels to pass through the traffic light corresponding to the traffic light information.

The wireless communication device 15 performs two-way wireless communications (also called inter-vehicle communication) with a wireless communication device of another vehicle. A communication system used in the inter-vehicle communication may employ a dedicated short range communication (DSRC), which is used in, for example, an electronic toll collection (ETC: registered trade mark) system. Further, the communication system used in the inter-vehicle communication may employ radio beacon and light beacon, which are used in a vehicle information and communication system (VICS: registered trade mark). Alternatively, the communication system may use radio wave in 700 MHz band whose use-classification in Japan was restructured after the end of analog television broadcasting at 2011. The radio wave in 700 MHz band may be prone to diffract because its wavelength is longer than that in 5.8 GHz. Therefore, in an urban area with crowded buildings, the radio wave in 700 MHz band allows excellent commutations even behind a corner of a building.

In accordance with commands from the controller 16, the wireless communication device 15 transmits positional information and speed information of the own vehicle, which are generated by the locating device 10, to an outside of the vehicle. For example, the controller 16 regularly issues the transmission command to the wireless communication device 15.

The controller 16 may include a microcomputer with a central processing unit (CPU), a read-only memory (ROM), a random access memory (RAM) or the like. The controller 16 organizes and controls respective devices of the in-vehicle apparatus 1. In accordance with programs stored in the ROM or the like, the controller 16 executes a process relating to acquiring and updating the traffic light information through road-to-vehicle communication, a process relating to various driving assistances, or the like.

Specifically, based on the traffic light information, the controller 16 may provide driving assistance. The driving assistance includes, for example, providing information relating to a traffic light which the vehicle passes through next, performing travel control for smooth passage through the intersection, or the like.

Processes of the driving assist system 100 will be described.

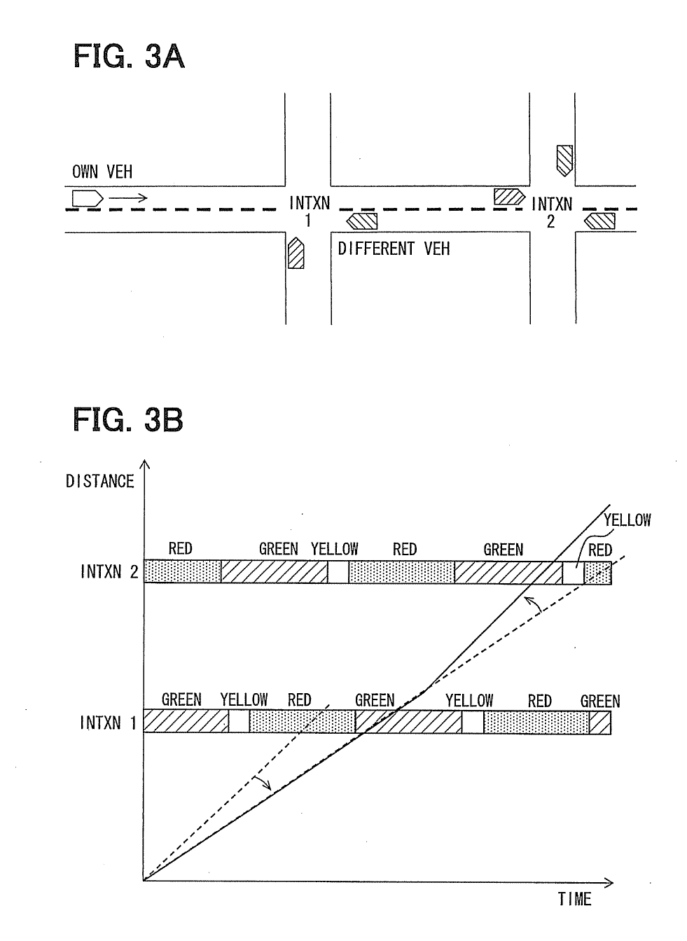

In the driving assist system 100, as shown in FIG. 3A, the in-vehicle apparatus 1 equipped in the own vehicle receives the vehicle information from different vehicles present near the intersections (the place around the own vehicle). In approaching the intersection 1 and the intersection 2, the own vehicle (specifically the in-vehicle apparatus 1) generates the traffic light information based on the vehicle information and notifies the appropriate speed that enables the own vehicle to pass through the traffic light of the intersection without making a stop.

Let us consider a situation where, as shown in FIG. 3B, when the own vehicle travels while keeping the present vehicle speed (see dashed line), the own vehicle reaches the intersection 1 and/or the intersection 2 at a time when the traffic light color is red. In this situation, the in-vehicle apparatus 1 prompts, by using the display device 12, the driver to accelerate or decelerate the own vehicle in order to enable the own vehicle to reach the intersection 1 and/or the intersection 2 at a time of green traffic color. If there is a certain speed that enables the passage through multiple intersections, the in-vehicle apparatus 1 prompts the driver to drive the vehicle at the certain speed.

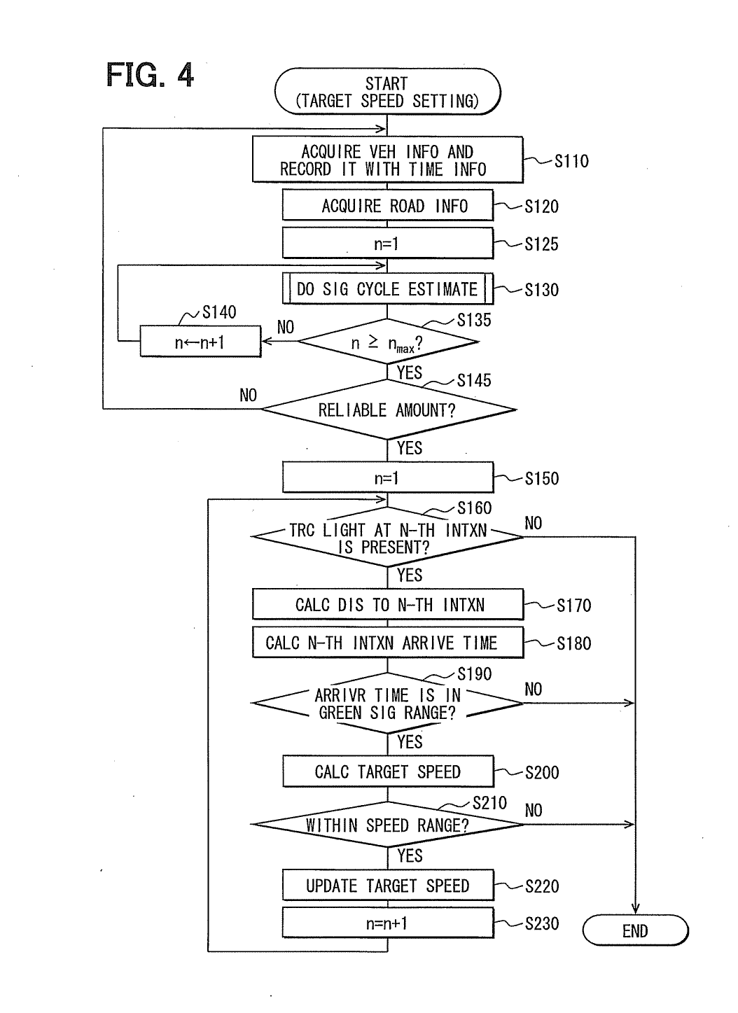

This operation of the in-vehicle apparatus 1 will be more specifically described with reference to FIG. 4. FIG. 4 is a flowchart illustrating a target speed setting process performed by the controller 16 of the in-vehicle apparatus 1. The target speed setting process may be started upon, for example, power-on of the in-vehicle apparatus 1. During the power-on, the target speed setting process may be repeatedly performed on a predetermined cycle (e.g., at predetermined intervals of 100 ms to 1000 ms)

In the target speed setting process, at S110, the controller 16 may acquire the information regarding the own vehicle and the different vehicles as much as the controller 16 can acquire now. For example, the controller 16 may acquire the vehicle information of the own vehicle and the different vehicle, including the position and speed. Thereafter, the controller 16 may store and accumulate the acquired information in association with a time and day of acquisition. This information may be retained for a predetermined time period. An amount of retainable vehicle information, which may relate to the number of vehicles, may be limited to a predetermined amount.

At S120, the controller 16 acquires road information. Specifically, from the database 14 (the navigation apparatus or the like), the controller 16 acquires the road information including information indicative of a speed limit of a road where the own vehicle travels, information indicative of traffic light location (and/or intersection location), and the like. The information indicative of the intersection location may be pre-stored in the database 14 as a part of map information of the database 14. Alternatively, the information indicative of the intersection location may be newly generated and recorded in the database 14 by the below-described intersection green time estimation process.

At S125, the controller 16 sets a variable “n” to 1. The variable “n” denotes an n-th nearest intersection in the traveling direction of the own vehicle, where the intersection denoted by the variable n is an intersection at which the traffic lights is present. In other words, intersections at which the traffic lights are absent are excluded from the intersections denoted by the variable n″. For example, the intersection “n=1” refers to an intersection that is nearest to the own vehicle in the traveling diction of the own vehicle and has a traffic light.

At S130, the controller 16 performs a traffic light cycle estimation process. In the traffic light cycle estimation process, the controller 16 estimates, on an intersection-by-intersection basis, traffic light cycle based on light color change information and traffic light location information. The light color change information indicates that light color of a traffic light has been changed. The traffic light location information indicates the location of this traffic light.

At S135, the controller 16 determines whether or not the variable “n” is greater than or equal to a maximum value n_MAX. The maximum value n_MAX may correspond to the maximum number of intersections as to which the determination is to be made. When the variable “n” is less than the maximum value n_MAX (No at S135), the process proceeds to S140 where the variable “n” is incremented. After S140, the process returns to S130.

When the variable “n” is greater than or equal to the maximum value (YES at S135), the process proceeds to S145. At S145, the controller 16 determines whether or not the amount of acquired vehicle information reaches a reliable information amount. In the above, the reliable information amount refers to an amount of information required to ensure reliability in estimating the traffic light cycle.

When the amount of vehicle information does not reach the reliable information amount (NO at S145), the process returns to S110. When the amount of vehicle information reaches the reliable information amount (YES at S145), the process proceeds to S150. At S150, the controller 16 sets the variable “n” to 1.

At S160, the controller 16 determines whether or not there is the traffic light information concerning the n-th intersection. Specifically, the controller 16 determines whether or not the traffic light information (the information indicative of the traffic light cycle and the intersection location) concerning the n-th intersection has been acquired as the road information.

When there is no traffic light information concerning the n-th intersection (NO at S160), the target speed setting process is ended. When there is the traffic light information concerning the n-th intersection (YES at S160), the process proceeds to S170. At S170, the controller 16 calculates a distance to the n-th intersection. The distance to the n-th intersection is also referred to herein as intersection distance.

Specifically, the controller 16 may calculate the intersection distance by using the travel speed and travel time of the own vehicle. When the own vehicle is not equipped with the light beacon receiver 34 or when a predetermined time or more has elapsed since the information was received from the light beacon transmitter, the controller 16 may calculate the intersection distance by using (i) the information which is distributed from a roadside unit 6 and is indicative of latitude and longitude of the intersection having the traffic light and (ii) the information which is indicative of the present position (latitude and longitude) of the own vehicle detected by the locating device 10. The intersection distance may be recorded in a memory device such as the RAM or the like, and may be read out and used in the following process.

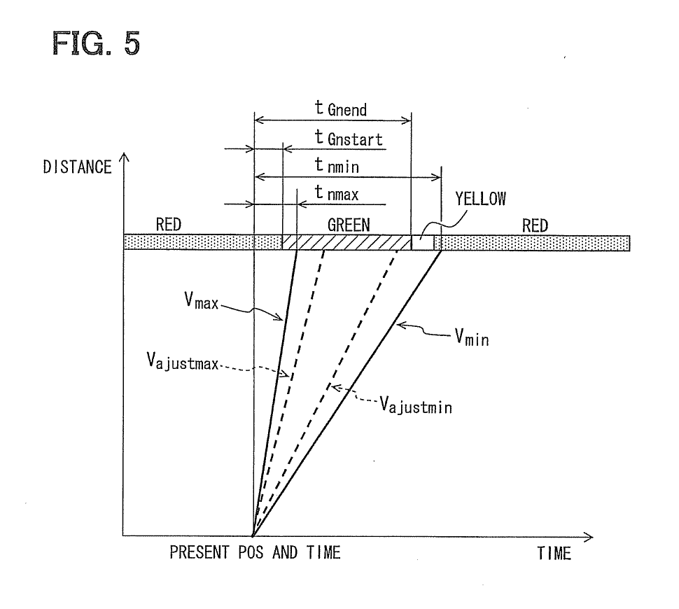

At S180, the controller 16 calculates a time taken for the own vehicle to reach the n-th intersection. In the present disclosure, the following notation is used (see also FIG. 5),

“Vmax” is defined as an upper limit speed.

“Vmin” is defined as a lower limit speed.

“Vn” is defined as speed in approaching the n-th intersection.

“dn” is defined as a distance to the n-th intersection.

“d0” is defined as a distance that the own vehicle with speed Vn and deceleration α travels before making a stop.

“tn” is defined as a time taken for the vehicle with the speed Vn and deceleration α to make a stop.

“tnmax” is defined as a time taken for the own vehicle to reach the n-th intersection when the own vehicle travels at the upper limit speed. “tnmax” may correspond to a minimum time taken to reach the intersection.

“tnmin” is defined as a time taken for the own vehicle to reach the n-th intersection when the own vehicle travels at the lower limit speed. “tnmin” may correspond to a maximum time taken to reach the intersection.

“tGnstart” is defined as a time taken for the traffic light at the n-th intersection to become green. When the traffic light is already green, tGnstart is zero.

“tGnend” is defined as a time for the traffic light at the n-th intersection to end green.

“Vnmax” is defined as an upper limit speed for the own vehicle to pass through the green traffic light of the n-th intersection.

“Vnmin” is defined as a lower limit speed for the own vehicle to pass through the green traffic light of the n-th intersection.

“Vajustmax” is defined as an upper limit of common target speed.

“Vajustmin” is defined as a lower limit of common target speed.

“α” is defined as a set deceleration.

According to the above notation, tnmax is a time taken for the own vehicle at the upper limit speed Vmax to reach the n-th intersection, tnmin is a time taken for the own vehicle traveling at the lower limit speed Vmin to reach the n-th intersection. Thus, tnmax and tnmin can be expressed as:

tₙₘₐₓ=dₙ/Vₘₐₓ (1)

tₙₘᵢₙ=dₙ/Vₘᵢₙ (2)

The upper limit speed Vmax employed in this embodiment is, whichever is smaller, a speed limit of a lane where the own vehicle travels, or, a speed of a preceding vehicle if the preceding vehicle is present. The lower limit speed Vmax may be set to a speed that does not obstruct a traffic flow. The lower limit speed Vmax may be set to, for example, 30 km/h.

At S190, the controller 16 determines whether or not at least part of the time for arrival (the time for arrival is a time range from tnmax to tnmin) overlaps with a time range from tGnstart to tGnend, which is a time range where a target traffic light at a target intersection is green color. In other words, the controller 16 determines whether or not the following relation (3) is satisfied.

tₙₘₐₓ<t_{Gnend} and tₙₘᵢₙ>t_{Gnstart} (3)

When the relation (3) is not satisfied (NO at S190), the target speed setting process is ended because the own vehicle's passage through the n-th intersection without the stop at the n-th intersection is impossible. When the relation (3) is satisfied (YES at S190), the controller 16 calculates a target speed at S200 because the own vehicle can pass through the n-th intersection without making a stop at the n-th intersection.

Specifically, the controller 16 performs the following. When n=1, the controller 16 calculates a target speed as V1max and V1min. In this calculation, when the traffic light transitions from red to green before the own vehicle approaches the intersection, the controller 16 calculates the target speed so that at a time when the own vehicle is at a certain distance before the traffic light, the traffic light transitions from red to green. In the above, the certain distance is set depending on the speed of the own vehicle.

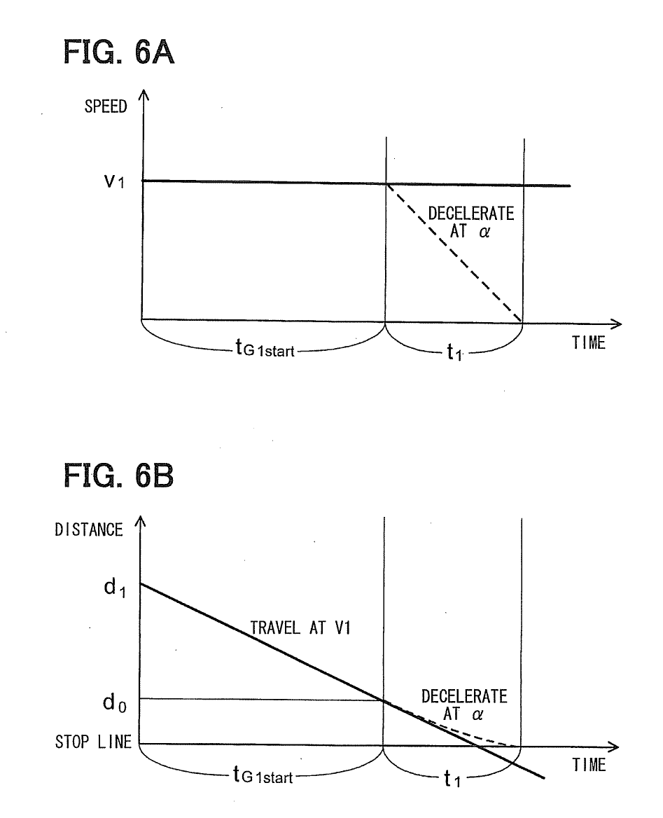

Specifically, as shown in FIGS. 6A and 6B, from the relations given as d0=V1/2α, t1=V1/α and (d1−d0)/V1=tG1start, the target speed V1max and V1min is set, so that the light color of the traffic light transitions from red to green at a time when own vehicle is at the distance d0 before the intersection. It should be noted that when the own vehicle is at the distance d0 before the intersection, the own vehicle can stop before the intersection by decelerating at the deceleration α. Specifically, the target speed V1max and V1min is set from the following relation.

V₁ₘₐₓ=min(((α²t_{G1start}²+2αd₁)^{1/2}−αt_{G1start}), Vₘₐₓ) (4)

V₁ₘᵢₙ=max((d₁/t_{Glend),} Vₘᵢₙ) (5)

In the expressions (4) and (5), min(x1, x2, . . . ) is the least of x1, x2, . . . , and max(x1, x2, . . . ) is the greatest of x1, x2, . . .

Additionally, an initial value of a target speed range, which is a maximum target speed range, is set to V1max and V1min with use of the following relations (6) and (7).

Vₐⱼᵤₛₜₘₐₓ=V₁ₘₐₓ (6)

Vₐⱼᵤₛₜₘᵢₙ=V₁ₘᵢₙ (7)

When n=2 or n>2, the target speed is calculated as follows.

Vₙₘₐₓ=min(((α²tGₙₛₜₐᵣₜ²+2dₙ)^{1/2}−αtGₙₛₜₐᵣₜ), Vₘₐₓ) (8)

Vₙₘᵢₙ=max((dₙ/tG_{nend}), Vₘᵢₙ) (9)

In the above way, the target speed (target speed range) is calculated. It should be noted that the target speed given by the equations (8) and (9) is the target speed calculated for the passage through only the n-th intersection. Thus, at S210, the controller 16 determines whether or not the target speed (target speed range) calculated for the n-th intersection is within the range of the target speed calculated (set) for the (n−1)-th intersection. In other words, the controller 16 determines whether or not the own vehicle can pass through the (n−1)-th intersection, which is one before the n-th intersection, at a speed within the calculated target speed range.

Vₙₘₐₓ≦Vₐⱼᵤₛₜₘₐₓ and Vₙₘᵢₙ≧Vₐⱼᵤₛₜₘᵢₙ (10)

Failure to satisfy the condition given as the expression (10) means that the own vehicle traveling at a constant speed cannot pass through the n-th intersection. Satisfaction of the condition given as the expression (10) means that the own vehicle traveling at a constant speed can pass to at least the n-th intersection. Because of this, when the target speed calculated for the n-th intersection is within the range of the target speed calculated for the (n-1)-th intersection (YES at S210), the previously-calculated target speed is overwritten with the target speed calculated this time.

Specifically, the following relation is used to select and update Vajustmax and Vajustmin.

Vₐⱼᵤₛₜₘₐₓ=min(Vₙₘₐₓ, Vₐⱼᵤₛₜₘₐₓ) (11)

Vₐⱼᵤₛₜₘᵢₙ=max(Vₙₘᵢₙ, Vₐⱼᵤₛₜₘᵢₙ) (12)

After S220, the process proceeds to S230. At S230, the controller 16 increments the variable n. Thereafter, for the (n+1)-th intersection, the controller 16 performs S160 and subsequent steps. When the target speed calculated for the n-th intersection is not within the range of the target speed calculated for the (n−1)-th intersection (NO at S210), the target speed setting process is ended.

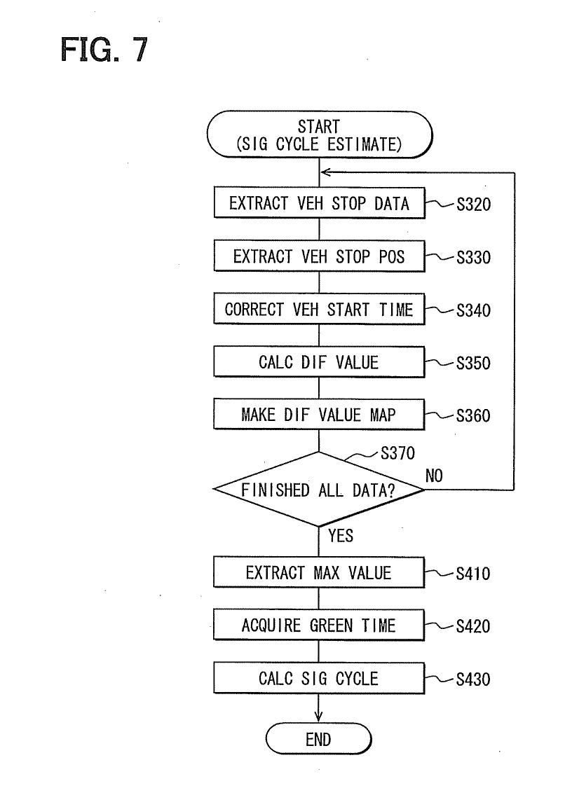

A signal cycle estimation process will be described with reference to a flowchart illustrated in FIG. 7. At S320, the controller 16 extracts a vehicle stop data associated with the same intersection and the same time. In the above, the vehicle stop data is classified according to intersection and according to time (e.g., classified on a calendar basis such as a day of week, a day of the year and the like, classified on a 2-6 hours basis such as morning, daytime, evening, early morning, midnight and the like).

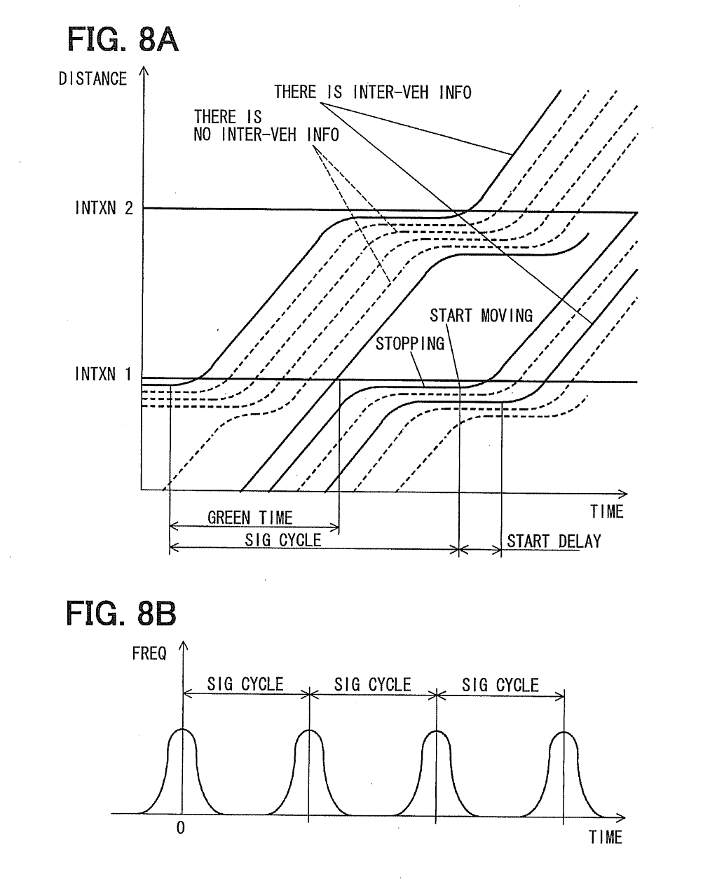

The vehicle stop data will be more specifically described with reference to FIG. 8A. FIG. 8A is a graph illustrating a relation between time and position of vehicle. Since the in-vehicle apparatus 1 repeatedly acquires the position of the own vehicle and the position of different vehicle (S110), the in-vehicle apparatus 1 can make a graph of the position of each vehicle as a function of time (see FIG. 8A). At S320, the vehicle information from (i) a predetermined distance before the n-th intersection (ii) to the n-th intersection is acquired.

At S330, the controller 16 extracts a vehicle stop position of each vehicle from the vehicle information extracted at S320. In FIG. 8A, each of the solid lines and dashed lines represents a vehicle movement. A horizontal portion of each of the solid lines and dashed lines shows that the vehicle is stopping and that the distance to the n-th intersection does not vary with the time. At S330, the distances from the respective stopping vehicles to the n-th intersection are detected. In FIG. 8A, the dashed line indicates a predicted position of a vehicle that has not the function to transmit the vehicle information. The position of the vehicle not having the function to transmit the vehicle information can be estimated from the position of the vehicle that transmits the vehicle information.

At S340, the controller 16 makes a correction to a vehicle start time based on the distance to the intersection. In the above, the vehicle start time refers to a certain point where the distance to the intersection starts varying with time after the distance does not vary with time in FIG. 8A. Specifically, in FIG. 8A, the certain point is a right end of the horizontal portion of each line. The vehicle start time may be delayed depending on the position of the vehicle, specifically, depending on the number of vehicles waiting in line at red light and the distance to the intersection. Thus, at S340, the controller 16 delays the vehicle start time by making a correction to the vehicle start time based on the distance to the intersection (e.g., delay the vehicle start time by 3 seconds every 8 meters).

At S350, the controller 16 calculates a difference value between the present time and each of the corrected vehicle start times, and makes a difference value distribution map. The difference value distribution map indicates a degree of dispersion of difference values (time), and can be illustrated as a graph of a relation between the difference value (time) and the frequency (vote count).

At S370, the controller 16 determines whether or not the processing on all of the vehicle stop data acquired at S110 has been performed. Specifically, the controller 16 determines whether or not the controller 16 has performed S320 to S360 for all of the vehicle information of the vehicles associated with the same intersection among the vehicle information acquired at S110. When the processing has not been performed on all of the vehicle stop data (NO at S370), the process returns to S320 to perform the processing on a rest of the vehicle stop data.

When the processing on all of the vehicle stop data has been finished (YES at S370), the process proceeds to S410 and S420 to acquire the difference value distribution map (see FIG. 8B). For example, at S410, the controller 16 extracts a time corresponding to a maximum value of the distribution. At S420, the controller 16 acquires green time by performing the below-described intersection green time estimation process.

At S430, the controller 16 calculates the traffic signal cycle based on intervals between the maximum values of the distribution (see FIG. 8B). For example, the traffic signal cycle may be calculated based on an average interval between the maximum values of the distribution. Alternatively, the traffic signal cycle may be calculated based on a weighted average interval between the maximum values. The weighted average interval may be obtained by giving a larger weighting coefficient to the interval closer to the present time and by giving a smaller weighting coefficient to the other intervals.

The traffic signal cycle includes information indicative of duration of light color of the traffic light. The green time indicated just after start of the traffic signal cycle may be regarded as the green light color; and the light color after this green light color until the end of the traffic signal cycle may be regarded as the light color other than green. After S430, the traffic signal cycle estimation process is ended.

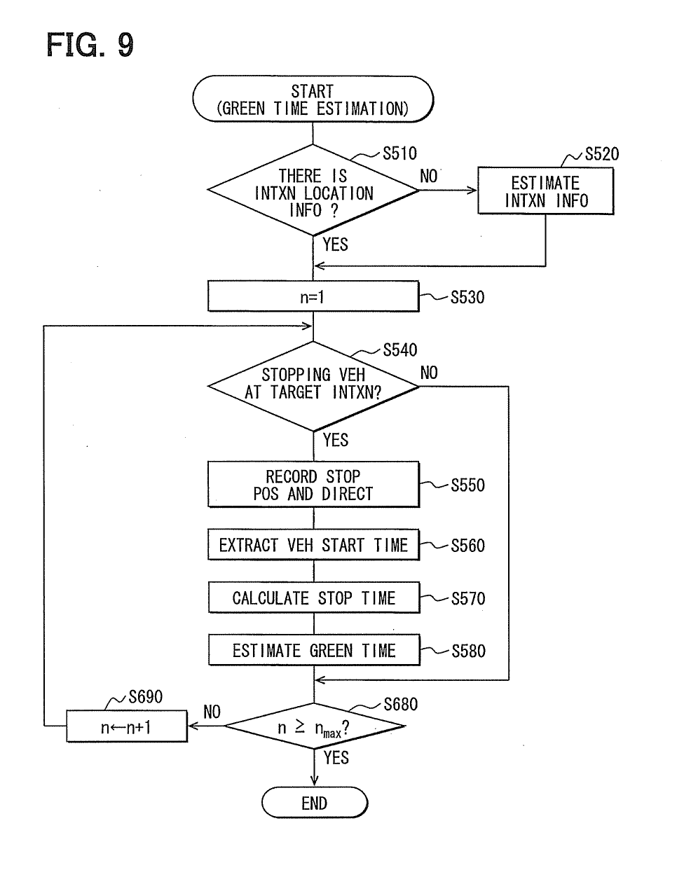

Now, a process for (i) estimating the intersection location and the green time of traffic light in cases where the intersection location (traffic light location) is unknown will be described with reference to FIG. 9. FIG. 9 is a flowchart illustrating the intersection green time estimation process performed by the controller 16.

At S510, the controller 16 determines whether or not the database 14 includes information indicative of an intersection located within a predetermined distance of the own vehicle (e.g., located within 500 meters of the own vehicle). When the database 14 includes the information indicative of the location of the intersection (YES at S510), the process proceeds to S530.

When there is no information indicative of the location of the intersection (NO at S510), the process proceeds to S520. At S520, the controller 16 estimates the location of the intersection based on the vehicle stop positions. Specifically, by referring to behaviors of respective vehicles indicated by the graph of FIG. 8A or the like, the controller 16 estimates that the location of the intersection is a point of several meters after the point where multiple vehicles stop for predetermined time or more and thereafter start moving. The controller 16 records this estimated location of the intersection in the database 14. It should be noted that even when there is the information indicative of the location of the intersection, S520 may be performed to find out a new traffic light.

At S530, the controller 16 sets the variable “n” to 1. At S540, the controller 16 determines whether or not there is a stopping vehicle at a target intersection, which is the n-th intersection. Specifically, based on whether or not the vehicle stop data is present, the controller 16 determines whether or not there is a stopping vehicle at the target intersection. When there is no stopping vehicle at the target intersection (NO at S540), the process proceeds to S680.

When there is a stopping vehicle at the target intersection (YES at S540), the process proceeds to S550. At S550, the controller 16 records the stop position and the heading direction of the stopping vehicle (which indicate a positional relationship between the vehicle stop position and the intersection). At S560, the controller 16 extracts a time when the stopping vehicle starts moving. This stopping vehicle is also called herein a process-target vehicle.

At S570, the controller 16 calculates a time period of the stop of the process-target vehicle, based on a stop start time and a movement start time of the process-target vehicle. At S580, based on the heading direction of the process-target vehicle and the time period of the stop of the process-target vehicle, the controller 16 estimates the green time of the traffic light present in the heading direction of the own vehicle.

Specifically, the controller 16 recognizes whether the process-target vehicle is present on the road on which the own vehicle is present or the process-target vehicle is present on a road intersecting with the road on which the own vehicle is present. When the process-target vehicle is present on the road on which the own vehicle is present, the controller 16 determines that the traffic light is (estimated to be) green before and after the stop of the process-target vehicle. When the process-target vehicle is present on the road intersecting with the road on which the own vehicle is present, the controller 16 determines that traffic light is (estimated to be) green during the stop of the process-target vehicle. The controller 16 performs this processing for multiple vehicles and determines that the green traffic color time is a time during which the light color of the traffic light is determined to be green for all of the multiple vehicles.

At S680, the controller 16 determines whether or not the variable “n” reaches its maximum value n_max. When the variable “n” is less than n_max (NO at S680), the controller 16 increments the variable “n” at S690, and the process returns to S540. When the variable “n” reaches n_max (YES at S680), the traffic signal estimation process is ended.

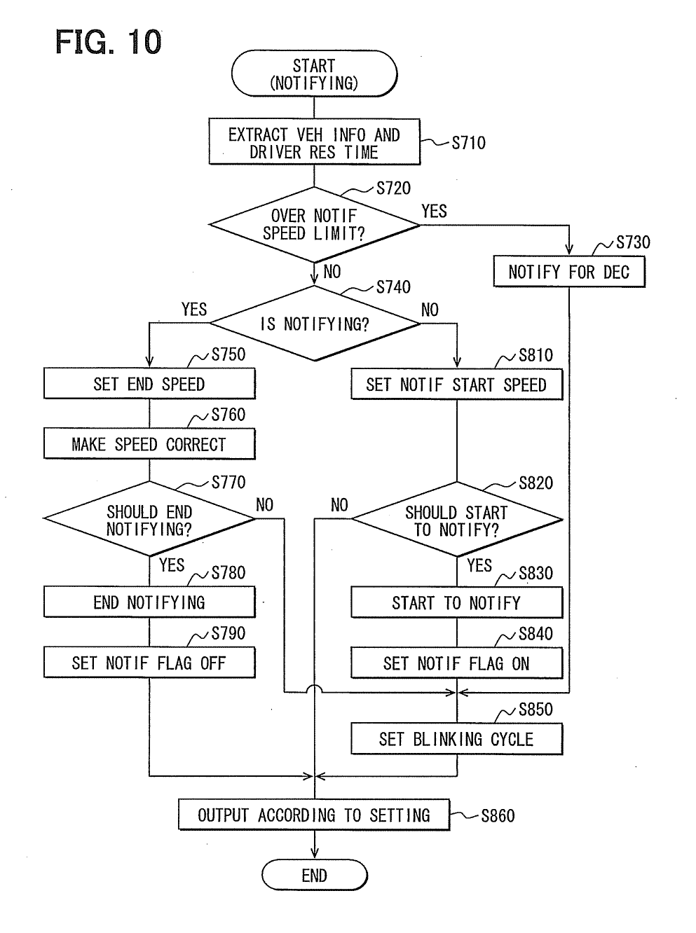

Next, a notification process for issuing a notification to prompt the own vehicle to enter the intersection in the green color of the traffic light will be described with reference to FIG. 10. FIG. 10 is a flowchart illustrating the notification process performed by the controller 16.

The notification process, which is performed in parallel with the target speed setting process, is started upon the power on of the in-vehicle apparatus 1. After the power on, the notification process is repeatedly performed at predetermined intervals.

At S710, from the RAM, the controller 16 extracts a variety of information needed in this notification process, such as the vehicle information, a driver response time, and the like. The controller 16 performing S710 may correspond to a response time acquisition device or means. At S720, the controller 16 determines whether or not the speed of the own vehicle exceeds a speed limit of the road on which the own vehicle travels.

When the speed of the own vehicle exceeds the speed limit of the road on which the own vehicle travels (YES at S720), the process proceeds to S730. At S730, the controller 16 sets up the notification for deceleration. The controller 16 performing S730 may correspond to a second notification device or means. After S730, the process proceeds to S850. At S850, the controller 16 sets up a notification manner.

When the speed of the own vehicle does not exceed the speed limit (NO at S720), the process proceeds to S740. At S740, the controller 16 determines whether or not the notification is being given. The determination of whether or not the notification is being given is made based on, for example, a notification flag state.

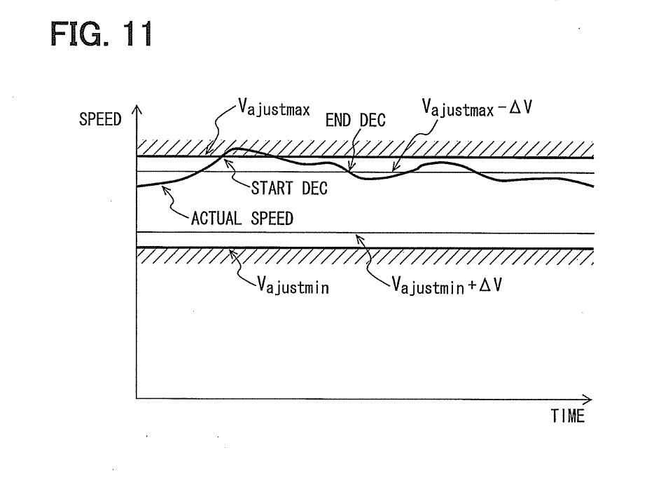

When the notification is being given (YES at S740), the process proceeds to S750. At S750, the controller 16 sets a notification end speed. Now, the notification end speed will be specifically explained with reference to FIG. 11. FIG. 11 is a graph illustrating a relation between the speed of the own vehicle and notification start speed and a relation between the speed of the own vehicle and notification end speed. For example, as shown in FIG. 11, when the speed of the own vehicle exceeds the target speed of Vajustmax, the notification end speed is set to Vajustmax−ΔV. When the speed of the own vehicle falls below the target speed of Vajustmin, the notification end speed is set to Vajustmin−ΔV. The ΔV may be set to, for example, 5% to 10% of the target speed.

At S760, the controller 16 makes a correction to the notification end speed in accordance with characteristics of the driver. To do so, the response time of the driver may be detected in advance and stored in a memory device such as RAM and the like. The response time may be, for example, a time between (i) when the in-vehicle apparatus 1 issues some instructions to the driver such as issuing the notification and (ii) when the driver performs an operation corresponding to the instructions. Based on this response time, the controller 16 makes a correction to the notification end speed so that, on assumption that the driver continues the present operation (driver's acceleration or deceleration operation), the own vehicle has the corrected notification end speed after the response time.

In other words, if the notification is given to the driver at a time of the after-correction notification end speed, the speed will be the before-correction notification end speed after the response time, which is a time period for the driver to respond to the notification.

At S770, the controller 16 determines whether or not the notification should be ended. Specifically, the controller 16 determines whether or not the speed of the own vehicle matches the notification end speed. When the speed of the own vehicle matches the notification end speed, the controller 16 determines that the notification should be ended. When the notification should be ended (YES at S770), the process proceeds to S780. At S780, the controller 16 sets to end the notification. At S790, the controller 16 sets the notification flag in OFF state.

When the notification should not be ended (NO at S770), the process proceeds to S850, which will be later described in detail. When it is determined at S740 that the notification is not being given (NO at S740), the process proceeds to S810. At S810, the controller 16 sets the notification start speed. For example, as shown in FIG. 11 a high speed side notification start speed (Vajustmax) and a low speed side notification start speed (Vajustmin) are set as the notification start speed. As seen from FIG. 11, the speed at which the notification is started (Vajustmax or Vajustmin) is different from the speed at which the notification is ended (Vajustmax−ΔV or Vajustmin+ΔV). Therefore, once the notification is started, the notification continues for a while. Likewise, once the notification is ended, the notification is prohibited for a while.

At S820, the controller 16 determines whether or not the notification should be started. Specifically, the controller 16 determines whether or not the speed of the own vehicle matches the notification start speed. When the speed of the own vehicle matches the notification start speed, the controller 16 determines that the notification should be started.

When the notification should not be started (NO at S820), the process proceeds to S860, which will be later described in detail. When the notification should be started (YES at S820), the process proceeds to S830. At S830, the controller 16 sets to start the notification. At S840, the controller 16 sets the notification flag in ON state. At S850, the controller 16 sets a blinking cycle of an acceleration deceleration indicator image 12b.

Specifically, at S850, the speed of the own vehicle is compared with the target speed (target speed range). In this regard, if the speed of the own vehicle exceeds the target speed, the lighting color of the acceleration deceleration indicator image 12b is set to red. If the speed of the own vehicle falls below the target speed, the lighting color of the acceleration deceleration indicator image 12b is set to green. Additionally, the blinking cycle of the acceleration deceleration indicator image 12b is set, so that the larger the difference between the speed of the own vehicle and the target speed (the speed limit) is, the smaller the blinking cycle is.

For example, the blinking cycle may be set within a range between 0.5 Hz and 2.0 Hz. In this range, it is highly-unlikely (low possibility) that the driver mistakes the blinking for continuous lighting-up and that the blinking annoys the driver.

At S860, the controller 16 outputs a signal to the display device 12 to control the display device 12 according to the setting. After S860, the notification process is ended. S860 may be omitted when the system does not display anything with the display device 12. When the controller 16 outputs the signal to the display device 12, the display device 12 may light up or blink the acceleration deceleration indicator image 12b according to the set condition.

In the present embodiment, the in-vehicle apparatus 1 can correspond to a driving assist apparatus. The signal cycle estimation process, which is performed by the controller 16, can correspond to a traffic light information acquisition device or means, a light color change prediction device or means, and a light color change information generation device or means. The intersection green time estimation process, which is performed by the controller 16, can correspond to a traffic light information acquisition device or means, a light color change prediction device or means, a light color change information generation device or means, and a traffic light location information generation device or means.

The target speed setting process, which is performed by the controller 16, can correspond to vehicle information acquisition device or means, a passage speed calculation device or means, and a recording device or means. The road information adding process, which is performed by the controller 16, can correspond to a road travel determination device or means, a road adding device or means. The notification process, which is performed by the controller 16, can correspond to an assist device or means.

In the driver assist system 100, the controller 16 acquires light color change information and traffic light location information from at least one of the own vehicle and the different vehicle. The light color change information is information indicating that light color of a certain traffic light has been changed. The traffic light location information is information indicative of the location of this traffic light. Based on the light color change information and the traffic light location information, the controller 16 predicts a time of changing the light color of the traffic light. Additionally, the controller 16 acquires information indicative of the position of the own vehicle, and assists the driving of the own vehicle in accordance with the predicted time of changing the light color of the traffic light.

In the driver assist system 100, the controller 16 acquires vehicle information, which includes information indicative of position of the different vehicle and speed of the different vehicle, from the different vehicle transmitting the vehicle information. Based on the vehicle information, the controller 16 estimates (i) a time when the different vehicle makes a stop and starts traveling, and (ii) a traffic light that causes the different vehicle to make the stop. Additionally, based on the time when the different vehicle makes a stop and starts traveling, the controller 16 generates the light color change information.

Additionally, based on the vehicle information, the controller 16 in the driver assist system 100 estimates a position where the different vehicle stops. Based on the position where the different vehicle stops, the controller 16 generates the traffic light location information. According this driver assist system 100, since the vehicle information can be acquired from the different vehicle and since the light color change information and the traffic light location information are generated in the own vehicle, it is possible to recognize the change in light color of the traffic light even when the transmitter transmitting the traffic light information is absent. The driver assist system 100 can provide the assistance in accordance with the light color change time.

Furthermore, according to the driver assist system 100, once the vehicle information including information indicative of the position and speed can be acquired from the different vehicle, the light color change information and the traffic light location can be obtained without acquisition of the light color change information and the traffic light location from an external of the own vehicle. Therefore, the traffic light information can be obtained from a small amount of information.

Based on (i) the distance to the intersection obtained from the position of the own vehicle and the location of the traffic light and (ii) the time of changing the light color of the traffic color, the controller 16 of the driver assist system 100 calculates a passing speed, which represents a speed enabling the own vehicle to pass through the traffic light without stopping. Thereafter, the driver is assisted to drive the own vehicle at the passing speed.

According to this configuration, since it is possible to provide the assistance for avoiding the stop of the own vehicle, it is possible to contribute to fuel efficiency improvement and environmental load reduction.

Additionally, when the passing speed is out of a preset speed range, the controller 16 of the driver assist system 100 does not provide the assistance.

According to this configuration, since a guide to an extreme passing speed is prohibited, a traffic flow is not disturbed. Furthermore, the controller 16 of the driver assist system 100 records the light color change information and the traffic light location information in association with acquisition time of the light color change information and the traffic light location information. The controller 16 predicts the time of changing the light color of the traffic light based on, among the stored the light color change information and the traffic light location information, the light color change information and the traffic light location information that are associated with the acquisition time having a similarity to the present time. In the above, the acquisition time is similar to the present time when there is a match of one of the following conditions. The conditions include day of the week, hours (e.g., morning, evening etc.), holiday, money collection day, and the like.

According to the above driver assist system 100, it is possible to predict the time of changing the light color by predicting the traffic signal cycle according the time. Therefore, even if the traffic signal cycle varies according to the time, it is possible to appropriately predict the traffic signal cycle.

### Other Embodiments

Embodiments of the present disclosure are not limited to the foregoing embodiment and can have various forms.

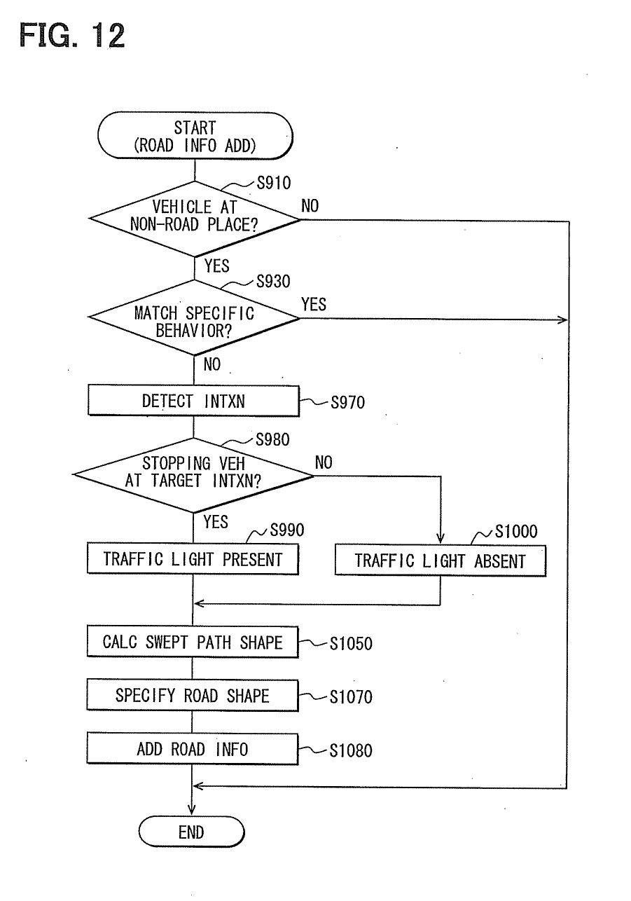

For example, in the foregoing embodiment, when the information indicative of the intersection location is not present, the information indicative of the intersection location is added to the map information (database 14). In this regard, not only the information indicative of the intersection location but also the information indicative of the road location may be added. For example, a road information adding process illustrated in a flowchart of FIG. 12 may be performed. The road information adding process, which is performed by the controller 16, is started upon the power-on of the vehicle. The road information adding process is performed in parallel with other processes.

At S910, the controller 16 makes a determination as to a region where a relevant vehicle, which is the own vehicle or the different vehicle, is traveling. Specifically, the controller 16 may determines whether or not the relevant vehicle is traveling on a place not registered as the road in the map information of the relevant vehicle. When the relevant vehicle is traveling on the road contained in the map information of the relevant vehicle (NO at S910), the road information adding process is ended.

When the relevant vehicle is traveling on a place not registered as the road in the map information of the relevant vehicle (YES at S910), the process proceeds to S930. At S930, the controller 16 determines whether or not a behavior of the relevant vehicle matches a specific behavior. The specific behavior includes, for example, a characteristic behavior occurring when the vehicle travels on not a road but a parking lot or the like. Specifically, the specific behavior includes U-turn, low-speed, spiral path and the like. Additionally, the specific behavior may include a characteristic behavior of the vehicle which is traveling on a place outside the road in the map information and has not returned to the road. The specific behavior is pre-stored in the database 14.

When the behavior of the relevant vehicle matches the specific behavior (YES at S930), the road information adding process is ended. When the behavior of the relevant vehicle does not match the specific behavior (NO at S930), the intersection is deemed as detected (S970).

At S980, the controller 16 determines whether or not a stopping vehicle is present in the intersection. When the stopping vehicle, which is a vehicle other than the relevant vehicle, is present in the intersection (YES at S980), a traffic light is deemed present in the intersection (S990). When the stopping vehicle is not present in the intersection (NO at S980), a traffic light is deemed absent in the intersection (S1000).

The determination at S980 as to whether or not a stopping vehicle is present in the intersection is made in order to determine whether or not there is a traffic light in the intersection. To highly accurately determine whether or not there is a traffic light in the intersection, it may be determine whether or not a behavior of another vehicle matches a preset specific behavior. The preset specific behavior is, for example, as follows: a certain vehicle on a certain road continues to stop although there is no vehicle on a road intersecting with the certain road on which the certain vehicle is present.

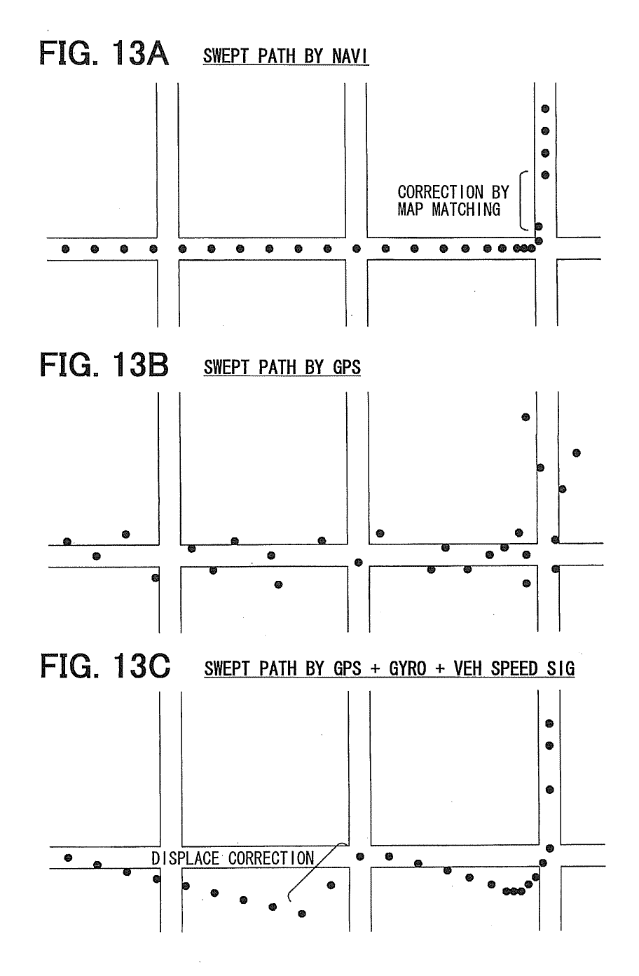

At S1050, the controller 16 calculates shape of a vehicle swept path of this vehicle around the detected intersection. The shape of a vehicle swept path will be specifically explained with reference to FIGS. 13A to 13C. FIG. 13A is a diagram illustrating the vehicular swept path obtained by map matching of a navigation apparatus. FIG. 13B is a diagram illustrating the vehicular swept path obtained only by GPS (global positioning system). FIG. 13C is a diagram illustrating the vehicular swept path obtained by a combination of GPS, gyro sensor and vehicle speed sensor.

As shown in FIG. 13A, when the vehicular swept path is calculated by map matching, the obtained vehicle swept path generally runs along a road shape (map data) although positioned points occasionally jump due to error correction of the map matching. However, in the road information adding process, the road shape is to be generated in a no-map-data region. Thus, the obtained vehicle swept path should be like that illustrated in FIG. 13B or FIG. 13C.

For example, as shown in FIG. 13B, in the case of the vehicle swept path obtained only by GPS, a line time-sequentially connecting the positioned points is remarkably-complicated curved line, and as a result, the obtained road shape is far from an actual road shape. Likewise, as shown in FIG. 13C, the vehicular swept path obtained by the combination of GPS, gyro sensor and vehicle speed sensor provides a road shape that is far from an actual road shape. This is because the position correction is occasionally made due to correction of GPS (see FIG. 13C for the displacement correction).

In view of the foregoing, in the present road information adding process, the controller 16 specifies a road shape based on travel histories of multiple vehicles (S1070). For example, at S1070, the controller 16 specifies a most probable road shape by calculating a fitted curve or a smooth approximate curved line of respective positioned points of traveling histories of multiple vehicles based on least squares method.

At S1080, the obtained road shape and the intersection location (in addition to the presence and absence of a traffic light) are added as map information to the database 14. After S1080, the road information adding process is ended.

In the driver assist system 100 of this modification example, the controller 16 determines whether or not the relevant vehicle, which is the own vehicle or the different vehicle, is traveling on the road contained in the map information. When the relevant vehicle is traveling the place other than the road contained in the map information, the controller 16 adds a new road to the map information based on a position history of the relevant vehicle.

According to the driver assist system 100 of this modification example, a new road not contained in the map information can be added to the map information. Additionally, the newly-generated information on the traffic light can be added to the map information.

Furthermore, in the driver assist system 100 of the modification example, the controller 16 specifies a road shape based on position histories of multiple vehicles, and adds the specified road shape to the map information. Therefore, the driver assist system 100 of this modification example can register an optimized road shape. Additionally, registration of an unlike road shape to the map information can be prevented.

Furthermore, in the driver assist system 100 of the modification example, the controller 16 specifies a road shape based on position histories of multiple vehicles, and adds the specified road shape to the map information. Therefore, the driver assist system 100 of this modification example can register an optimized road shape. Additionally, registration of an unnatural road shape as the map information can be prevented.

Furthermore, in the driver assist system 100 of the modification example, even when the relevant vehicle, which is the own vehicle or the different vehicle, is traveling a place not registered as the road in the map information, the controller 16 prohibits the map information addition if the behavior of the relevant vehicle based on the position history matches the pre-prepared characteristic behavior. Note that the pre-prepared characteristic behavior may be a behavior of a vehicle traveling on a path that is not a road.

According to the driver assist system 100 of this modification example, since the map information addition is prohibited when the behavior matches the characteristic behavior, the registration of a non-road as a road can be prohibited. For example, when the vehicle travels not a road but a parking lot or the like, the behavior matches the characters behavior such as U-turn behavior, low speed, spiral path (multistory parking lot) or the like.

In the foregoing embodiments, the driver assist system 100 provides driving assistance by prompting acceleration and deceleration in accordance with the change in traffic light color. However, this is merely an example. It is possible to provide any driving assistance as long as the driving assistance can assist the driving of the own vehicle. For example, the driver assist system 100 may notify the change in traffic light color, may control the vehicle based on the change in traffic light color, or may perform other operations

According to the present disclosure, a driving assistance apparatus can be configured in various forms. For example, according to one example, a driving assist apparatus for being mounted to an own vehicle to assist a driving operation of a driver of the own vehicle may include a traffic light information acquisition device, a light color change prediction device, an own vehicle position acquisition device, and an assist device. The traffic light information acquisition device may acquire light color change information and traffic light location information from at least one of the own vehicle and a different vehicle different than the own vehicle. The light color change information may be information indicating that light color of a traffic light has been changed. The traffic light location information may be information indicative of location of the traffic light. The light color change prediction device may predict, based on the light color change information and the traffic light location information, a light color change time, which is a time of changing the light color of the traffic light. The own vehicle position acquisition device may acquire information indicative of position of the own vehicle. The assist device may assist the driving of the own vehicle in accordance with the position of the own vehicle and the light color change time.

According to the above configuration, since the light color change information and the traffic light location information are acquired from at least one of the own vehicle and the different vehicle, the driving assist apparatus can recognize a change in light color of a traffic light even when there is no transmitter for transmitting traffic light information. Additionally, the driver assist system can provide the assistance in accordance with the light color change time.

In the above driving assist apparatus, any assistance for the driving of the own vehicle may be employed. For example, the driving assist apparatus may be configured to notify the change in traffic light color, may be configured to control the vehicle based on the change in traffic light color, or may be configured to perform other operations.

The driving assist apparatus may further comprise a vehicle information acquisition device and a light color change information generation device. The vehicle information acquisition device may acquire vehicle information, which includes information indicative of position of the different vehicle and speed of the different vehicle, from the different vehicle transmitting the vehicle information. Additionally, the vehicle information acquisition device may accumulate the acquired vehicle information. Based on the vehicle information, the light color change information generation device may estimate (i) a time when the different vehicle stats moving or stops, and (ii) the traffic light that causes the different vehicle to stop. Additionally, the light color change information generation device may generate the light color change information based on the time when the different vehicle stats moving or stops.

In the above estimation of the traffic light causing the different vehicle to stop, if map data or the like can tell the location of the traffic light (location of the corresponding intersection), a nearest traffic light may be estimated as the traffic light causing the different vehicle to stop. Alternatively, travel paths of multiple vehicles may be monitored to specify crossing points where the travel paths of the multiple vehicles cross each other. Then, the crossing point nearest to the position where the different vehicle started moving or stopped may be estimated as the location of the traffic light.

According to the above configuration, when it is possible to acquire from the different vehicle the vehicle information including the information indicative of the position and speed of the different vehicle, it is possible to obtain the light color change information without acquiring the light color change information from an outside of the own vehicle. If the traffic light causing the different vehicle to stop is unknown, the driving assist apparatus may estimate the traffic light in the following way.

A traffic light location information generation device of the driving assist apparatus may estimate, based on the vehicle information, a different vehicle stop position, which is a position where the different vehicle stops. Additionally, the traffic light location information generation device may generate the traffic light location information based on the different vehicle stop position. For example, the drive assist apparatus may estimate the different vehicle stop position as the location of the traffic light. Alternatively, the drive assist apparatus may estimate that the traffic light is located a predetermined distance from the different vehicle in the heading direction of the different vehicle.

According to the above configuration, when it is possible to acquire from the different vehicle the vehicle information including the information indicative of the position and speed of the different vehicle, it is possible to obtain the light color change information without acquiring the light color change information from an outside of the own vehicle. Therefore, by acquiring a small amount of information, it is possible to achieve the advances.

The driving assist apparatus may further comprise a passing speed calculation device that calculates a passing speed, which represents a speed enabling the own vehicle to pass through the traffic light without stopping, based on (i) a distance to the traffic light, which is obtained based on the position of the own vehicle and the location of the traffic light, and (ii) the time of changing the light color. The assist device may provide the assistance for driving the vehicle at the passing speed.

According to this configuration, it is possible to provide the assistance for non-stop of the own vehicle, and as a result, it is possible to improve fuel efficiency and reduce environmental burden.

In the driving assist apparatus, when the passing speed calculated by the passing speed calculation device is out of a preset speed range, the assist device may be prohibited from providing the assistance.

According to this configuration, since a guide to an extreme passing speed is prohibited, a traffic flow is not disturbed.

The driving assist apparatus may further comprise a road travel determination device and a road addition device. The road travel determination device may determine whether or not, a relevant vehicle, which is one of the own vehicle and the different vehicle, is traveling on a road contained in pre-prepared map information. In cases where the relevant vehicle is traveling on a place other than the road contained in the map information, the road addition device adds a new road to the map information based on a position history of the relevant vehicle traveling the place other than the road contained in the map information.

According to this configuration, a new road not contained in the map information can be added to the map information. In adding the new road, the newly-generated information on the traffic light may be added to the map information.

The road travel determination device may determine, for each of multiple vehicles, whether or not the each of the multiple vehicles is traveling on the road contained in the map information. The road adding device may add the new road to the map information by determining a probable road shape of the new road based on position histories of the multiple vehicles that are not traveling on the road contained in the map information.

According to this configuration, even when an unnatural road shape is detected due to positioning errors, it is possible make a correction to the road shape. Thus, registration of an unnatural road shape in the map information can be prevented.

The road travel determination device may be configured as follows. Even when the relevant vehicle, which is one of the own vehicle and the different vehicle, is traveling the place other than the road contained in the map information, the road adding device is prohibited from adding the new road if a behavior of the relevant vehicle obtained from the position history matches a pre-prepared characteristic behavior, wherein the pre-prepared characteristic behavior occurs in cases where the relevant vehicle is traveling on a path other than the road.

According to the above configuration, for example, when the vehicle travels not a road but a parking lot or the like, the vehicle behavior may match such characteristic behaviors as U-turn, low-speed, spiral movement or the like, and the map information addition may be prohibited. Therefore, registration of a non-road place as the road can be prevented

The driving assist apparatus may further comprise a recording device that, upon acquisition of the light color change information, records the light color change information while associating the light color change information with an acquisition time of the light color change information, thereby storing a light color change information set. The light color change prediction device may predict the light color change time based on: of the stored light color change information set, the light color change information associated with the acquisition time that has a predetermined similarity to a present time. As for the predetermined similarity, if there is a coincidence of, for example, a day of the week, hours (morning, evening, or the like), a day of the year, holiday, money collection day or the like, it may be determined that the acquisition time has the predetermined similarity to the present time.

According to this configuration, the driving assist apparatus can estimate traffic signal cycle according to time to predict the light color change time.

According to another aspect of the present disclosure, a non-transitory computer-readable storage medium storing a computer-executable program that causes a computer to function as the driving assist apparatus can be provided.

This storage medium can also provide the same advantages as the driving assist apparatus can provide.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A driving assist apparatus for being mounted to an own vehicle to assist a driving operation of a driver of the own vehicle, the driving assist apparatus comprising:
a traffic light information acquisition device that acquires light color change information and traffic light location information from at least one of the own vehicle and a different vehicle different than the own vehicle, wherein:
the light color change information is information indicating that light color of a traffic light has been changed; and
the traffic light location information is information indicative of location of the traffic light;
a light color change prediction device that predicts a light color change time based on the light color change information and the traffic light location information, wherein the light color change time is a time of changing the light color of the traffic light;
an own vehicle position acquisition device that acquires information indicative of position of the own vehicle; and
an assist device that assists the driving of the own vehicle in accordance with the position of the own vehicle and the light color change time.

2. The driving assist apparatus according to claim 1, further comprising:
a vehicle information acquisition device that
acquires vehicle information, which includes information indicative of position of the different vehicle and speed of the different vehicle, from the different vehicle transmitting the vehicle information, and
accumulates the acquired vehicle information; and
a light color change information generation device that
estimates, based on the vehicle information,
(i) a time when the different vehicle stats moving or stops, and
(ii) the traffic light that causes the different vehicle to stop, and
generates the light color change information based on the time when the different vehicle stats moving or stops.

3. The driving assist apparatus according to claim 2, further comprising:
a traffic light location information generation device that
estimates, based on the vehicle information, a different vehicle stop position, which is a position where the different vehicle stops, and
generates the traffic light location information based on the different vehicle stop position.

4. The driving assist apparatus according to claim 1, further comprising:
a passing speed calculation device that calculates a passing speed, which represents a speed enabling the own vehicle to pass through the traffic light without stopping, based on
(i) a distance to the traffic light, which is obtained based on the position of the own vehicle and the location of the traffic light, and
(ii) the time of changing the light color of the traffic light,
wherein the assist device provides the assistance to drive the vehicle at the passing speed calculated by the passing speed calculation device.

5. The driving assist apparatus according to claim 4, wherein:
when the passing speed calculated by the passing speed calculation device is out of a preset speed range, the assist device is prohibited from providing the assistance.

6. The driving assist apparatus according to claim 1, further comprising:
a road travel determination device that determines whether or not a relevant vehicle, which is one of the own vehicle and the different vehicle, is traveling on a road contained in pre-prepared map information; and
a road addition device that, in cases where the relevant vehicle is traveling a place other than the road contained in the map information, adds a new road to the map information based on a position history of the relevant vehicle traveling the place other than the road contained in the map information.

7. The driving assist apparatus according to claim 6, wherein:
the road travel determination device determines, for each of multiple vehicles, whether or not the each of the multiple vehicles is traveling on the road contained in the map information; and
the road adding device adds the new road to the map information by determining a probable road shape of the new road based on position histories of the multiple vehicles that are traveling the place other than the road contained in the map information.

8. The driving assist apparatus according to claim 6, wherein:
even when the relevant vehicle, which is one of the own vehicle and the different vehicle, is traveling the place other than the road contained in the map information, the road adding device is prohibited from adding the new road if a behavior of the relevant vehicle obtained from the position history matches a pre-prepared characteristic behavior, wherein the pre-prepared characteristic behavior occurs in cases where the relevant vehicle is traveling on a path other than the road.

9. The driving assist apparatus according to claim 1, further comprising:
a recording device that, upon acquisition of the light color change information, records the light color change information while associating the light color change information with an acquisition time of the light color change information, thereby storing a set of light color change information,
wherein the light color change prediction device predicts the light color change time based on:
of the stored set of light color change information set, the light color change information that is associated with the acquisition time that has a predetermined similarity to a present time.

10. A non-transitory computer-readable storage medium storing a computer-executable program that causes a computer to function as the driving assist apparatus of claim 1.
